(19) United States
(12) Patent Application Publication
(10) Pub. No.: US 2007/0162648 A1
(43) Pub. Date: Jul. 12, 2007

(54) DMA Controller With Self-Detection For Global Clock-Gating Control

(76) Inventor: Ivo Tousek, Stockholm (SE)

Correspondence Address: BAKER & MCKENZIE LLP;PATENT DEPARTMENT, 2001 ROSS AVENUE, SUITE 2300, DALLAS, TX, 75201, US

(21) Appl. No.: 11/613,168

(22) Filed: Dec. 19, 2006

Related U.S. Application Data
(60) Provisional application No. 60/751,718, filed on Dec. 19, 2005.

(51) Int. Cl. G06F 13/28

(52) U.S. Cl. 710/22

(57) ABSTRACT

A standby self-detection mechanism in a DMA controller which reduces the power consumption by dynamically controlling the on/off states of at least one clock tree driven by global clock-gating circuitry is disclosed. The DMA controller comprises a standby self-detection unit, a scheduler, at least one set of channel configuration registers associated with at least one DMA channel, and an internal request queue which holds already scheduled DMA requests that are presently outstanding in the DMA controller. The standby self-detection unit drives a signal to a global clock-gating circuitry to selectively turn on or off at least one of the clock trees to the DMA controller, depending on whether the DMA controller is presently performing a DMA transfer.

This application claims the benefit of U.S. Provisional Application No. 60/751,718 filed Dec. 19, 2005.

### BACKGROUND OF THE INVENTION

1 . Field of the Invention

This invention relates to power management in computer systems, and more particularly to an advanced direct memory access (DMA) controller in a system with a standby self-detection capability.

2. Description of the Related Art

A typical computer system includes a central processing unit (CPU) coupled to one or more peripheral devices (e.g. disk drives and memory). The CPU monitors and controls the peripheral devices through a direct memory access (DMA) controller. A DMA device is a device which incorporates a DMA controller and is able to transfer data directly from the disk to primary storage.

Different peripheral devices may run at different clock frequencies than that in a CPU. As operating speed increases, power consumption also tends to increase. Only few programs or transactions require the full range of a processor bandwidth for a significant time interval. The power dissipated during the running of a computer system depends on the nature of the instruction and the devices. For this reason, most processors employ a clock gating mechanism to cut off the clock sources for the devices when they are not in use. Clock gating technique reduces the power consumption of the system. It, however, can also cause rapid current changes that will induce excess noises.

A popular method to save power consumption is to use clock-gating. This technique is typically used to clock-gate a few register elements in close vicinity to a clock-gating cell or so-called “local” clock-gating. However, if the hardware design is large in terms of register elements, a clock tree that fans out to a large number of clock-gating cells may still lose significant amount of power. Such is often the case in DMA controller designs which use a large number of register elements to increase the controller's DMA transfer performance. At the times when the DMA traffic is low within the system, unnecessary power comsumption will be lost in the clock tree(s) to the DMA controller when it is not transferring any data. Therefore, there is a need for an advanced DMA controller structure to further limit the power consumption of the traditional DMA controller solutions.

### SUMMARY OF THE INVENTION

The present invention provides a standby self-detection mechanism in a DMA controller which reduces the power consumption by dynamically controlling the on/off state of the clock trees to large parts of the DMA controller logic.

One aspect of the present invention contemplates a standby self-detection circuitry of a DMA controller. The standby self-detection circuitry comprises (1) a detection unit to detect whether the internal state signals associated with a DMA transfer are active, and (2) a clock output unit. The clock output unit, according to the detection result of said detection unit, drives an enable signal that selectively turns on/off a globally gated clock. When the DMA controller is not actively performing any DMA transfer, then the clock(s) is turned off. When a DMA transfer is performed, then the clock(s) is turned on and stays on as long as the DMA transfer is being performed.

Another aspect of the present invention provides a DMA controller which comprises a CPU bus interface unit and a DMA controller core. The CPU bus interface generates enable signals associated with active DMA requests to the DMA controller to selectively turn on/off a clock to the DMA controller core. The DMA controller can selectively turn on or off the clock (or clocks) depending on if the DMA controller is actively performing a DMA transfer.

Another aspect of the present invention provides a data processing apparatus which comprises a data processing unit, a DMA controller, and a global clock-gating circuitry. The DMA controller sends a signal to the global clock-gating circuitry to selectively turn on or off a clock (or clocks) to the DMA controller depending on whether the DMA controller is actively performing a DMA transfer.

Yet another aspect of the present invention provides a method for power management of a DMA controller. The method comprises the steps of (1) detecting whether the DMA controller is actively performing a DMA transfer, and (2) dynamically controlling the on/off states of a clock (or clocks) to said DMA controller.

### BRIEF DESCRIPTION OF THE DRAWINGS

The accompanying drawings are included to provide further understandings of the present invention, and are incorporated in and constitute a part of this description. The drawings illustrate embodiments of the present invention, and together with the description, serve to explain the scope of the present invention.

FIG. 1 illustrates a schematic diagram of a DMA controller according to a preferred embodiment of the present invention;

FIG. 2 illustrates a block diagram representation of a clock-gating element according to a preferred embodiment of the present invention;

FIG. 3 illustrates a circuit diagram representation of a standby self-detection unit according to a preferred embodiment of the present invention; and

FIG. 4 illustrates a circuit diagram representation of a global clock-gating circuitry 400 according to a preferred embodiment of the present invention.

FIG. 5 illustrates a flow chart of power management in a DMA controller according to an embodiment of the present invention.

### DESCRIPTION OF THE PREFERRED EMBODIMENTS

The invention disclosed herein is directed to a standby self-detection mechanism in a DMA controller which reduces the power consumption by dynamically controlling the on/off state of the clock trees to significant parts of the DMA controller logic. In the following description, numerous details are set forth in order to provide a thorough understanding of the present invention. It will be appreciated by one skilled in the art that variations of these specific details are possible while still achieving the results of the present invention.

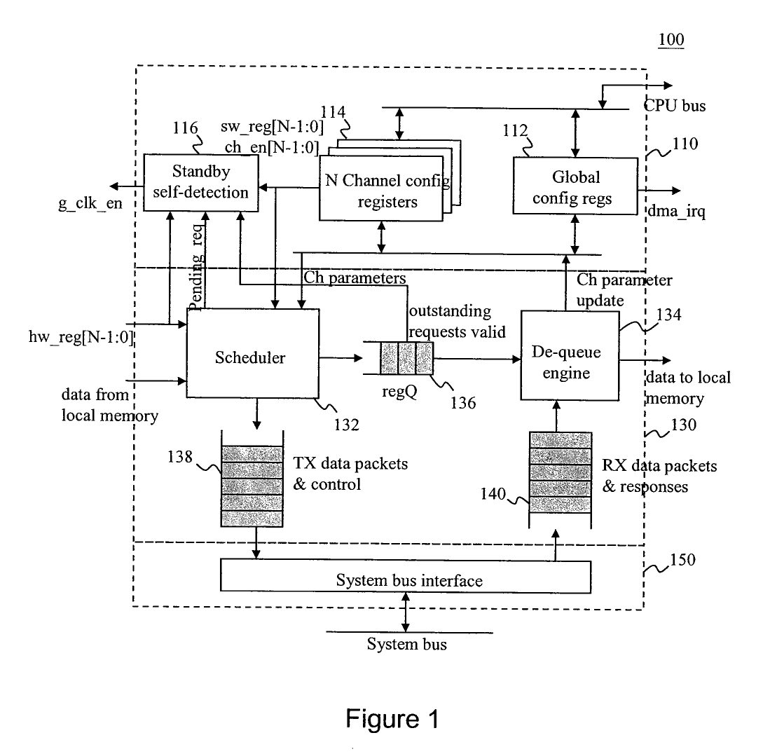

Referring now to FIG. 1, a schematic diagram of a DMA controller according to a preferred embodiment of the present invention is illustrated. The DMA controller 100 comprises a CPU bus interface 110, a control core 130 and an external bus interface 150. In one embodiment, the CPU bus interface 110 comprises (1) a plurality of global configuration registers 112, (2) channel configuration registers 114 associated with N DMA channels, and (3) a standby self-detection unit 116. The control core 130 comprises (1) a data packet Scheduler 132, (2) a DMA request De-queue engine 134, (3) a request queue (reqQ) 136 associated with multiple outstanding (scheduled) DMA requests, (4) write (TX) data packets and associated control queues 138, and (5) read (RX) data packets and associated control queues 140.

The DMA controller provides a number of DMA channels which can be configured over the CPU bus. In the example of a DMA controller, a DMA channel can be configured to transfer data between a first agent and a second agent. The first agent can be a local memory, while the second agent can be a system memory or a peripheral device accessible over the system bus. A plurality of channel enable and software request signals (ch_en[N-1:0], sw_req[N-1:0]) are sent from the channel configuration registers 114 to the standby self-detection unit 116 to indicate what DMA channels are enabled and whether an enabled DMA channel is associated with software requests (memory-to-memory DMA transfers).

Internally, the DMA controller manages a number of queues. Associated with each scheduled data packet transfer, the DMA controller places control information into the command queue 138, which describes how the packet transfer shall be performed over the system bus. In case of a TX data packet transfer, the DMA controller reads a data packet from local memory and places it along with control commands into the write data packets and command queues 138. In case of an RX data packet transfer, the RX data packet received over the system bus is placed into the read data packets queue 140. Status information associated with both TX and RX data packet are placed into the response queue (respQ) 140. All presently outstanding DMA requests (requests that are already scheduled for transfer but not yet completed) are tracked in the outstanding request queue (reqQ) 136. Each entry in the request queue (reqQ) 136 consists of descriptors that characterize a DMA request that is presently outstanding in the DMA controller's internal queues. An active entry in the head of the reqQ is matched against the responses from the respQ inside the de-queue engine 134. And when all responses associated with one DMA request have been processed, the reqQ entry is finally popped off the reqQ and the associated DMA channel's configuration parameters are updated.

Internally, the scheduler 132 arbitrates among all active DMA requests (software requests from the channel configuration registers and hardware requests hw_req[N-1:0] from system peripherals) for all enabled DMA channels and schedules the requests for DMA transfer. If the scheduled request is a DMA transfer from local memory to the system bus, then the request will be pending inside the scheduler 132 while the associated data packet is read from local memory into the write data packet queue 138. A pending request signal (pending_req) is also sent to the standby self-detection unit 116. When the complete packet has been read, the scheduler generates a descriptive transfer command into the command queue 138 and an outstanding request entry into the request queue 136. If the scheduled request is a DMA transfer from the system bus to local memory, the scheduler generates a descriptive transfer command into the command queue 138 and an outstanding request entry into the request queue 136. Associated with each presently outstanding request entry in the request queue 136, the request queue generates an outstanding request valid signal to the standby self-detection unit 116. All entries in the request queue will later be matched against the responses in the response queue. Read data packets from the read data packets queue will be transferred to local memory. An entry in the head of the request queue is outstanding until the matching process against all associated responses is completed. In other words, the associated packet transfer is complete when the entry in the head of the request queue is removed from the request queue.

The scheduler, the read/write interfaces to local memory, the internal queues and associated queue management logic and the de-queue engine need to be active only when a DMA request that is associated with an enabled DMA channel is active or when at least one request is outstanding in the DMA controller. In many systems, when large amounts of DMA traffic are requested, the size of the DMA controller's internal control and data queues may have a significant impact on the overall DMA performance. During the times of low DMA traffic, however, DMA requests may be active only occasionally. Thus, when the DMA traffic load is low, DMA controller hardware may clocked for no reason which causes unnecessary power consumption.

When not needed in the system, a DMA controller can be completely disabled to save power consumption by switching off all clocks globally to the DMA controller. When the clocks to the DMA controller are globally enabled, power consumption can be reduced only if the DMA controller is designed using well-known local clock-gating techniques. Note that when the DMA controller's clocks are globally enabled but the DMA controller is not performing any active DMA transfer, unnecessary power is still consumed in the clock tree(s). Thus, if the global clock-gating of the clock tree(s) to the DMA controller could be dynamically controlled, power consumption could be reduced. The present invention introduces a standby self-detection unit to achieve such a goal.

The standby self-detection unit 116 is used to detect whether a DMA transfer is active. An active DMA transfer relates to the point in time when an active DMA request is detected until the point when it is completed in the DMA controller. In one embodiment, the queues used are First-In-First-Out (FIFO). The standby self-detection unit drives the G_CLK_EN signal to a global clock-gating element to dynamically control the global clocks.

In one embodiment, the standby self-detection unit 116 provides the function of tracking a DMA transfer from the point when a request becomes active, through the point when the DMA request is scheduled and pending inside the DMA controller, to the point when the request is transferring through the DMA controller and popping off the reqQ. In other words, every state associated with the DMA transfer is tracked by the standby self-detection unit 116. If any of these states is active (which means the request is active), the standby self-detection unit 116 will drive its G_CLK_EN signal active to the global-clock gating element. If none of these states is active, then the standby self-detection unit 116 will drive its G_CLK_EN signal inactive to reduce unnecessary power consumption.

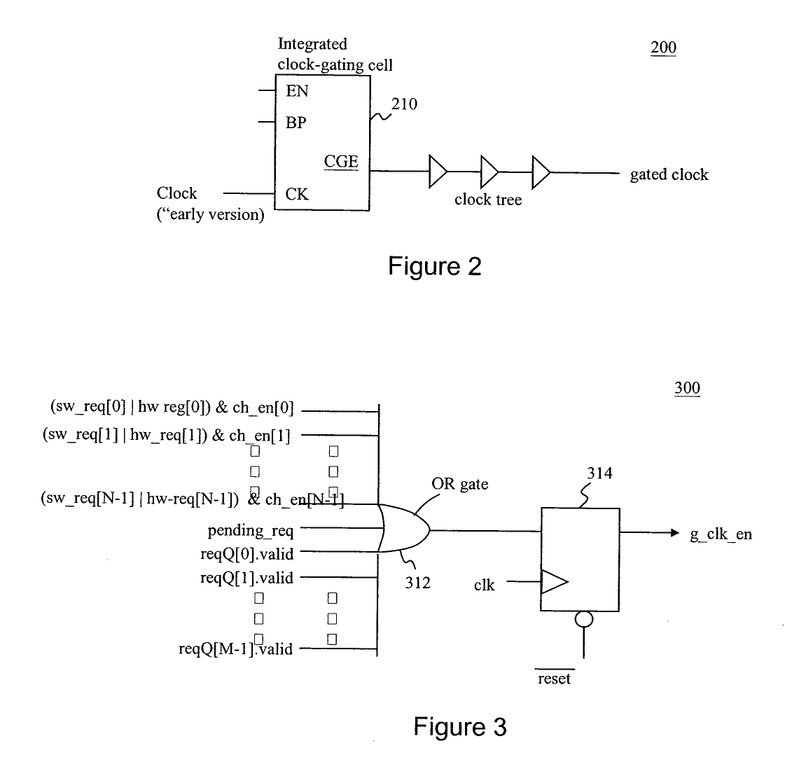

Referring now to FIG. 2, a representation of a well-known clock-gating element according to a preferred embodiment of the present invention is shown. The clock-gating element 210, when used as a global clock-gating element in a clock tree, drives the root clock signal (an early version of the clock tree) to its output when either of its EN or BP inputs is asserted. When the EN and BP inputs are both de-asserted, the clock tree will drive a constant logic zero. The BP input is usually controlled during chip test operation while the EN input is used in normal operation to enable or disable the propagation of the root clock signal through the clock-gating element. In the exemplary diagram, the clock input to the clock-gating cell is an early version of the corresponding leaf clocks driven by the clock tree. The clock-gating element outputs a gated version of the clock signal (gated clock).

Referring now to FIG. 3, a circuit diagram representation of a standby self-detection unit according to a preferred embodiment is shown. In one example, the standby self-detection unit 300 supports N DMA channels and an M-entry deep request queue FIFO. The self-detection unit 300 can either detect (1) an active DMA hardware or software request in any of the N DMA channels, or (2) a request that is internally pending in the DMA controller, or (3) a request that is presently outstanding in the DMA controller and placed in the reqQ. When any one of the inputs to the OR gate 312 is active, the flip-flop 314 of the standby self-detection unit will drive the G_CLK_EN output active, indicating that the gated clock(s) is active. When the gated clock(s) to the DMA controller are active, the scheduler may start processing any active requests. It is very important that from the point in time when the scheduler schedules the next request until the point when the outstanding request is popped from the request queue, the G_CLK_EN signal stays constantly active. This means that the scheduler may either raise its PENDING_REQ signal while scheduling an active request or it must immediately generate an entry to the request queue.

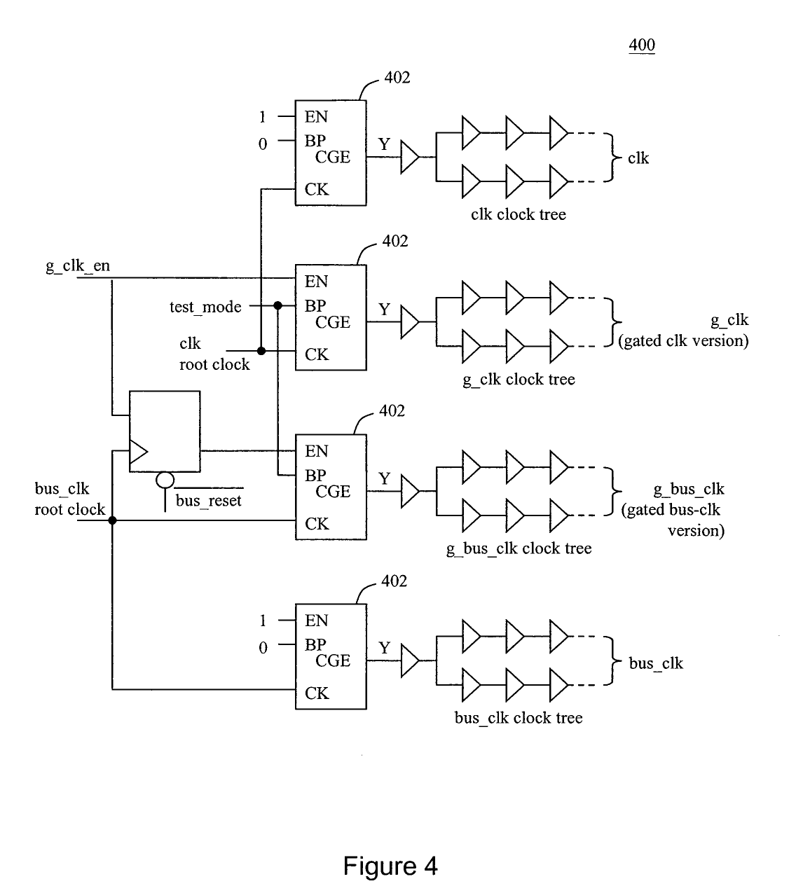

Referring now to FIG. 4, a circuit diagram representation of a global clock-gating circuitry 400 according to a preferred embodiment is illustrated. The indicated circuitry provides an example where the DMA controller is running off two asynchronous clocks: the CLK and the BUS_CLK clocks. In this example, a CLK clock is used to clock logic inside the DMA controller that always need be clocked by the CLK clock. Its gated version G_CLK is used to clock logic that needs be clocked by CLK only when a DMA transfer is active in the DMA controller. Similarly, a BUS_CLK clock is used to clock logic inside the DMA controller that always needs be clocked by the BUS_CLK clock while its gated version G_BUS_CLK is used to clock logic that needs be clocked by BUS_CLK only when a DMA transfer is active. In general, large system buses are often running at a lower frequencies than certain faster hardware modules. Therefore the system bus interface of the DMA controller may run synchronously with the system bus and the BUS_CLK clock, while other parts of the DMA controller may run synchronously with other logic, such as the processor or the CLK clock. Note that this is only an example and variations can be made according to different implementation requirements. Each clock of the global clock-gating elements 400 is outputted from a clock-gating element 402 as described in FIG. 2. Clock-gating elements associated with non-gated clock trees (the CLK and BUS_CLK clock trees in this example) are not mandatory. They are provided to simplify clock tree de-skewing between clock trees that are associated with synchronous clocks. Synchronization of the G_CLK_EN signal into an asynchronous clock domain (G_CLK_EN is generated in the CLK clock domain) is provided by an additional flip-flop (indicated by 403 in this example) for each clock domain that is asynchronous to the CLK clock.

In another embodiment of the present invention, the clock logic can be divided in two types: clock logic associated with DMA read operations and clock logic associated with DMA write operations. In this example, the gated clock is only active when performing either a read transfer or a write transfer. Thus, the standby self-detection unit will detect the transfer of such read/write transfer from the point when a read/write request is active, through the point in time when the read/write request is scheduled and pending in the reqQ, and during the read/write transfer until when the request is popped off the reqQ.

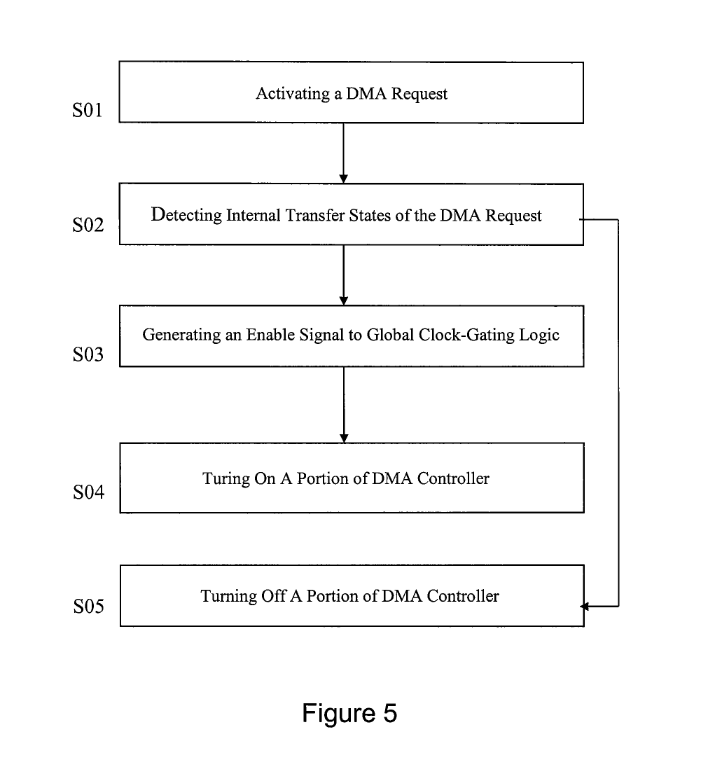

FIG. 5 is a flow chart which illustrates an embodiment of the present invention. In step S01, a DMA request is activated by either the channel configuration register or an external hardware device. In step S02, the standby self-detection unit detects the internal transfer state of the DMA request. If requested, the channel configuration register will send channel enable and software request signal to the standby self-detection unit. When the request is scheduled by the scheduler, the scheduler sends a pending request signal to the standby self-detection unit. While pending for processing, the reqQ also sends a request valid signal to the stanby self-detection unit. This way, every state associated with the DMA request can be closely monitored. If the standby self-detection unit detects that any of these signals is active, it will generate an enable signal to the global clock-gating logic in step S03. The global clock-gating logic is applied to a portion of the DMA controller having synchronous clocks. If the enable signal is asserted to the global clock-gating logic, then the portion of the DMA controller will be turned on in step S04. On the contrary, if the standby self-detection unit detects no active internal state, the enable signal is deasserted to the global clock-gating logic. Then in step S05 the global clock-gating logic will not output clock signals to the DMA controller, resulting in that the clock is turned off and that the power is saved.

Although the present invention has been described in considerable detail with references to certain preferred versions thereof, other variations are possible and contemplated. For example, the standby self-detection unit can control signals from other areas in the DMA controller. Moreover, although the present disclosure contemplates one implementation using FIFOs as queues, it may also be replaced with buffers or the like.

Finally, those skilled in the art should appreciate that they can use the disclosed embodiments as a basis for designing or modifying other structures for carrying out the same purpose of the present invention without departing from the spirit of the present invention as defined by the appended claims.

What is claimed is:

1. A self-detection unit of a DMA controller, comprising:
a detection unit that detects whether the internal state signals associated with a DMA transfer inside the DMA controller are active; and
a clock output unit that drives an enable signal to selectively turn on or off a globally gated clock according to the detection result of said detection unit,
wherein said enable signal turns on said globally gated clock in response to an active state of the internal state signals, and said enable signal turns off said globally gated clock in response to an inactive state of the internal state signals.

2. The self-detection unit of a DMA controller according to claim 1, wherein said detection unit is an OR gate with input of said internal state signal.

3. The self-detection unit of a DMA controller according to claim 1, wherein said globally gated clock is coupled to a global clock-gating circuit.

4. The self-detection unit of a DMA controller according to claim 3, wherein said global clock-gating circuit is applied to the portion of the DMA controller associated with a combination of the following operations:
a system bus interface operation;
a read transfer operation; and
a write transfer operation.

5. The self-detection unit of a DMA controller according to claim 1, wherein said internal state signal comprising a combination of the following:
a plurality of channel enable and request signals representing activation of said DMA transfer;
a plurality of request valid signals representing said DMA transfer is scheduled; and
a pending request signal representing said DMA transfer is outstanding.

6. A DMA apparatus, comprising:
a CPU bus interface that generates an enable signal to selectively turn on a global gated clock according to an internal state signal associated with an active request; and
a core unit that receives said global gated clock and is switched on in response to said global clock being turned on.

7. The DMA apparatus according to claim 6, wherein said core unit further comprising at least one DMA channel for performing DMA operations, and said CPU bus interface unit comprises at least one set of channel configuration registers associated with at least one DMA channel.

8. The DMA apparatus according to claim 7, wherein said CPU bus interface unit further comprises a self-detection unit for generating said enable signal.

9. The DMA apparatus according to claim 7, wherein said internal state signal comprises a channel enable and request signal that represents activation of said active request from said channel registers.

10. The DMA apparatus according to claim 6, wherein said core unit comprises a scheduler and at least one request queue, wherein said request queue holds entries associated with already scheduled and presently outstanding DMA requests.

11. The DMA apparatus according to claim 10, wherein said internal state signal comprises a pending request signal representing that said active request is scheduled by said scheduler.

12. The DMA apparatus according to claim 10, wherein said internal state signal comprises a request valid signal representing that said active request is outstanding in said request queue.

13. The DMA apparatus according to claim 10, wherein said request queue is a First-In First-Out (FIFO) data structure.

14. A method of power management in a DMA controller, comprising:
receiving and processing a DMA request;
detecting whether an internal state is active during said processing of said DMA request;
selectively turning on a global gated clock applied to a portion of said DMA controller according to the result of said detecting step.

15. The method according to claim 14, wherein said detecting step is performed by a self-detection unit in the DMA controller.

16. The method according to claim 14, wherein said internal state is a channel enable and request signal sent from a channel configuration register representing that said DMA request is processed by a DMA channel.

17. The method according to claim 14, wherein said internal state comprising a pending signal sent from a scheduler representing that said DMA request is scheduled by said scheduler.

18. The method according to claim 14, wherein said internal state comprising a valid signal sent from a request queue representing that said DMA request is outstanding in said request queue.

19. The method according to claim 14, further comprising the step of turning off said global gated clock signal in response to said internal state being inactive.

20. The method according to claim 14, wherein said global gated clock is applied to said portion of the DAM controller associated with the following operations:
a system bus operation;
a read operation; and
a write operation.
